(19) United States
(12) Patent Application Publication
(10) Pub. No.: US 2020/0371379 A1
(43) Pub. Date: Nov. 26, 2020

(54) EYEGLASSES AND FRAME THEREOF

(71) Applicant: PEGATRON CORPORATION, Taipei City (TW)

(72) Inventors: CHIH-HAO LU, Taipei City (TW); HSIN-MIN TIEN, Taipei City (TW)

(21) Appl. No.: 16/881,681

(22) Filed: May 22, 2020

(30) Foreign Application Priority Data
May 22, 2019 (TW) 108117721

(51) Int. Cl. G02C 1/00; G02C 1/06

(52) U.S. Cl. CPC G02C 1/10; G02C 13/001; G02C 1/06

(57) ABSTRACT

A pair of eyeglasses includes two lenses and a frame. The frame includes two ring bodies, two lens fasteners, two supporting units and at least two flexible fasteners. The two ring bodies are connected to each other, and the two ring bodies each respectively include a hollow area. The two lens fasteners are respectively connected to the two ring bodies and surround the hollow area, The two supporting units are respectively connected to the two ring bodies. The at least two flexible fasteners are respectively supported by the two supporting units, respectively located next to the two lens fasteners, and respectively combined with the two ring bodies. A groove is formed between the lens fastener and the flexible fastener which is adjacent to the lens fastener. The groove is used for fixing the lens.

### BACKGROUND

### 1. Technology Field

The present disclosure relates to a pair of eyeglasses and a frame thereof; more particularly, the present disclosure relates to a pair of eyeglasses and a frame which are easy to assemble for assembly workers, and the frame and the lens are not deformed during the assembly process.

### 2. Description of the Related Art

When people buy a pair of eyeglasses, they need to measure their vision first to get corrective lenses which match their vision; then assembly workers will assemble the lenses into the frame to form a complete pair of eyeglasses. As shown in FIG. 1(a), a common frame 800 is a rigid ring-shaped frame structure which has an outer fastening ring 810 and an inner fastening ring 820. The outer fastening ring 810 and the inner fastening ring 820 are respectively located on the side of the frame 800 close to the user's eye and the other side of the frame 800 away from the user's eye. A groove 830 is formed between the outer fastening ring 810 and the inner fastening ring 820, and the groove 830 is used for fixing the lens 900.

When an assembly worker assembles the lens 900 into the frame 800, the assembly worker must apply force to twist a part of the frame 800 and thereby cause the outer fastening ring 810 and the inner fastening ring 820 to turn outward. At this moment, the assembly worker can insert the lens 900 into the groove 830 between the outer fastening ring 810 and the inner fastening ring 820 which are turned outward. Then the assembly worker can sequentially apply force to twist the other part of the frame 800 to cause the periphery of the lens 900 to be housed completely in the twisting frame 800.

However, as shown in FIG. 1(b), during the assembly process, the twist force applied to the frame 800 may cause the frame 800 to be deformed such that a dimensional tolerance is generated between the groove 830 and the lens 900; this dimensional tolerance can affect the final assembly angle of the lens 900. Alternatively, the deformation of the frame 800 may apply pressure to the lens 900 such that the lens 900 may be deformed and the optical characteristics thereby affected, such as the focus being changed. In addition, as shown in FIG. 1(c), when the lens 900 is assembled with the frame 800, the lens 900 may be subjected to the twisting force applied by the assembly worker and become slightly deformed, which can affect the optical characteristics of the lens 900.

Therefore, there is a need to provide a new design for eyeglasses that provides easy assembly for the assembly worker and prevents deformation of the frame and the lens during the assembly process.

### SUMMARY

It is an object of the present disclosure to provide a pair of eyeglasses which is easy to assemble for the assembly worker and prevents deformation of the frame and the lens during the assembly process.

To achieve the abovementioned object, the pair of eyeglasses of the present disclosure includes two lenses and a frame. The frame includes two ring bodies, two lens fasteners, two supporting units and at least two flexible fasteners. The two ring bodies are connected to each other, and the two ring bodies respectively include a hollow area. The two lens fasteners are respectively connected to the two ring bodies and respectively surround the two hollow areas. The two supporting units are respectively connected to the two ring bodies. The at least two flexible fasteners are respectively supported by the two supporting units, are respectively located next to the two lens fasteners, and are respectively combined with the two ring bodies. Two grooves are respectively formed between each of the two lens fasteners and the flexible fastener which is adjacent to the lens fastener. Each of the two grooves is respectively used for fixing each of the two lenses.

According to one embodiment of the present disclosure, the flexible fastener includes a protruding part; each of the two grooves is formed between the lens fastener and the protruding part which is adjacent to the lens fastener.

According to one embodiment of the present disclosure, the ring body includes a combining part, the flexible fastener includes a corresponding combining part, and the combining part and the corresponding combining part are fastened to each other.

According to one embodiment of the present disclosure, each of the supporting units includes a blocking wall, and the blocking wall and the ring body which is corresponded to the blocking wall hold the flexible fastener correspondingly.

According to one embodiment of the present disclosure, the supporting unit includes a positioning part, the flexible fastener includes a positioning groove, and the positioning part is fastened to the positioning groove of the flexible fastener which is corresponded to the positioning part.

According to one embodiment of the present disclosure, the at least two flexible fasteners are made of rubber or silicone.

According to one embodiment of the present disclosure, the lens includes a first sub-lens and a second sub-lens, and the first sub-lens is connected to the second sub-lens.

According to one embodiment of the present disclosure, the combining part is a protruding block, and the corresponding combining part is a C-shaped structure.

Another object of this disclosure is to provide a frame which is easy for the assembly worker to assemble without deforming the frame and the lens during the assembly process.

To achieve the abovementioned object, the frame of this disclosure is applied to a pair of eyeglasses. The pair of eyeglasses includes a lens. The frame includes a ring body, a lens fastener, a supporting unit and a flexible fastener. The ring body includes a hollow area. The lens fastener is connected to the ring body and surrounds the hollow area. The supporting unit is connected to the ring body. The flexible fastener is supported by the supporting unit and located next to the lens fastener, and it is combined with the ring body. A groove is formed between the lens fastener and the flexible fastener which is adjacent to the lens fastener, and the groove is used for fixing the lens.

According to one embodiment of the present disclosure, the combining part is a protruding block, and the corresponding combining part is a C-shaped structure; or wherein the combining part is a C-shaped structure, and the corresponding combining part is a protruding block.

### BRIEF DESCRIPTION OF THE DRAWINGS

FIG. 1(a) to FIG. 1(c) illustrate section drawings of a lens installed in the frame of the prior art.

FIG. 2 illustrates a schematic drawing of the pair of eyeglasses in a first embodiment of the present invention.

FIG. 3 illustrates a partial section drawing of the frame in the first embodiment of the present invention.

FIG. 4 illustrates a partial section drawing of the lens in the groove in the first embodiment of the present invention.

FIG. 5 illustrates a schematic drawing of the frame in a second embodiment of the present invention.

FIG. 6 illustrates the schematic drawing of the ring body, the supporting unit and the flexible fastener combined with each other in a third embodiment of the present invention.

FIG. 7 illustrates the schematic drawing of the ring body, the supporting unit and the flexible fastener combined with each other in a fourth embodiment of the present invention.

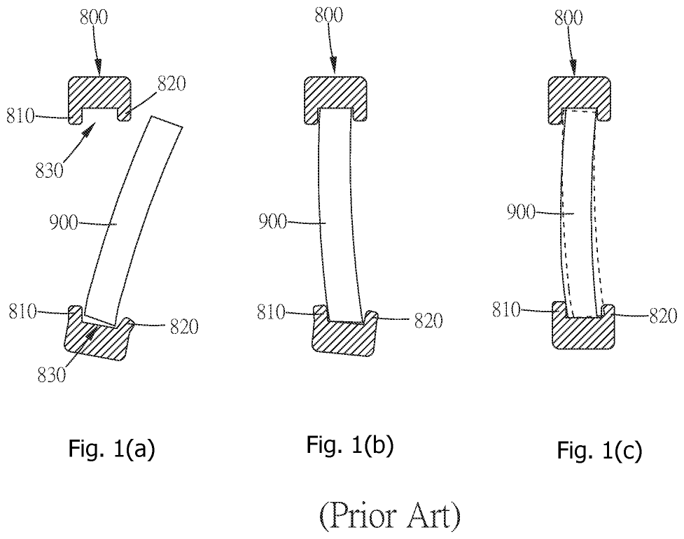

### DETAILED DESCRIPTION OF THE PREFERRED EMBODIMENT

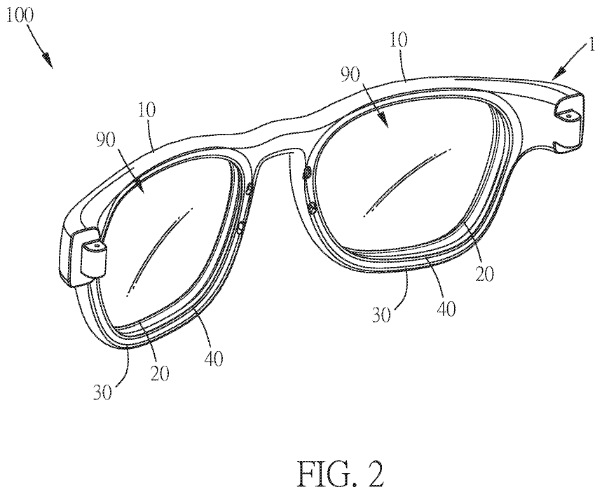

Please refer to FIG. 2 to FIG. 4, which illustrate the pair of eyeglasses and the frame in a first embodiment of the present invention. FIG. 2 illustrates a schematic drawing of the eyeglasses in the first embodiment of the present invention.

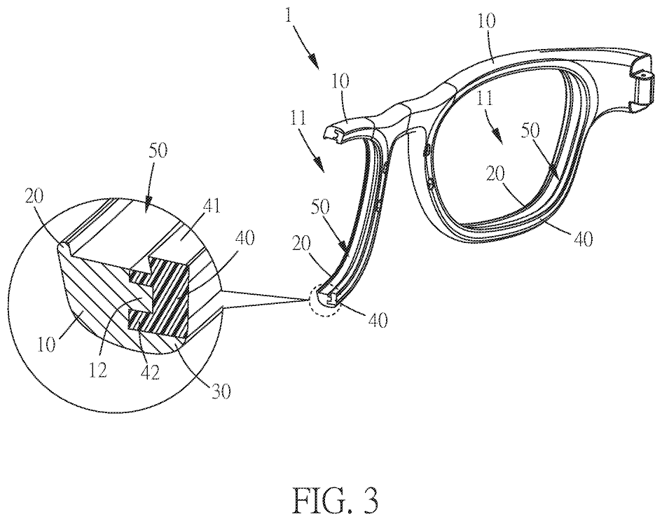

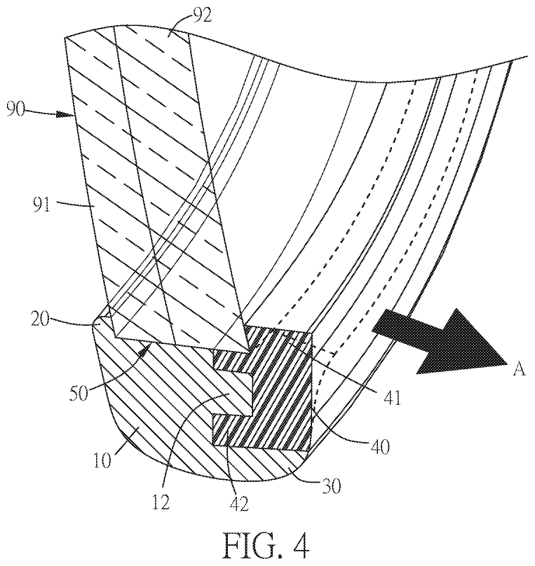

FIG. 3 illustrates a partial section drawing of the frame in the first embodiment of the present invention. FIG. 4 illustrates a partial section drawing of the lens in the groove in the first embodiment of the present invention.

As shown in FIG. 2 and FIG. 4, in the first embodiment of the present invention, the pair of eyeglasses 100 includes two lenses 90 and a frame 1. In this embodiment, the lens 90 is a compound lens made of a plurality of lenses, such as a compound lens with an augmented reality function or a compound lens of presbyopia glasses. Each of the lenses 90 includes a first sub-lens 91 and a second sub-lens 92, and the first sub-lens 91 is overlappingly connected to the second sub-lens 92; however, the type of the lens 90 is not limited to the compound lens and can also be a single-piece lens.

As shown in FIG. 2 to FIG. 4, in the first embodiment of the present invention, the frame 1 includes two ring bodies 10, two lens fasteners 20, two supporting units 30 and two flexible fasteners 40. However, the amounts of the ring bodies 10, the lens fasteners 20, the supporting units and the flexible fasteners 40 of the frame 1 are not limited to two; the amounts of those units can be respectively changed to one according to the user's requirement (for example, if the user needs to correct the vision of only one eye).

The two ring bodies 10 are made of a hard material such as plastic or metal, and the two ring bodies 10 are connected to each other. The two ring bodies 10 each respectively include a hollow area 11 and a combining part 12. The hollow area 11 is used for containing the lens 90. The combining part 12 is a protruding block for combining with the flexible fastener 40.

In the first embodiment of the present invention, the two lens fasteners 20 are two ring-shaped structures, the two lens fasteners 20 are respectively connected to the outside (which is the side away from the user's eye) of the two ring bodies 10, and the ring-shaped structure of the lens fastener 20 surrounds the hollow area 11. The lens fastener 20 is used in combination with the flexible fastener 40 to fasten the lens 90.

In the first embodiment of the present invention, the two supporting units 30 are respectively connected to the two ring bodies 10, and the supporting units 30 are used for supporting the flexible fasteners 40. In this invention, the two ring bodies 10, the two lens fasteners 20 and the two supporting units 30 are a one-piece structure such that the connection structure between the two ring bodies 10, the two lens fasteners 20 and the two supporting units 30 is stable, and the structure cannot easily be deformed by an external force.

In the first embodiment of the present invention, the two flexible fasteners 40 are two ring-shaped structures made of rubber or silicone. The two flexible fasteners 40 are respectively supported by the two supporting units 30 and respectively surround the hollow areas 11 of the two ring bodies 10. The two flexible fasteners 40 are respectively located next to the two lens fasteners 20; the two flexible fasteners 40 and the two lens fasteners 20 are respectively and substantially arranged in parallel. The two flexible fasteners 40 are respectively combined with the two ring bodies 10. Each of the flexible fasteners 40 includes a protruding part 41 and a corresponding combining part 42. Two grooves 50 are respectively formed between each of the two lens fastener 20 and the protruding part 41 of the flexible fastener 40 which is adjacent to the lens fastener 20. Each of the grooves 50 is used for fixing each of the lenses 90. The corresponding combining part 42 is a C-shaped structure, and the combining part 12 is fastened to the C-shaped structure of the corresponding combining part 42; via the fastening between the combining part 12 and the corresponding combining part 42, the ring body 10 is combined with the flexible fastener 40 stably. However, the material of the flexible fastener 40 is not limited to rubber and silicone; the flexible fastener 40 can also be made of other flexible and elastic materials. Because the flexible fastener 40 is flexible, when the flexible fastener 40 is used to fasten the lens 90, the flexible fastener 40 will not excessively compress the lens 90, such that the lens 90 will not be deformed permanently under excessive pressure; more particularly, the abovementioned compound lens is less likely to be compressed such that its structure is altered.

As shown in FIG. 4, when an assembly worker assembles the lens 90 into the frame 1, the assembly worker can push the protruding part 41 along the opening direction A; at this moment, because the flexible fastener 40 is made of rubber or silicone, which has great flexibility and elasticity, the assembly worker can easily push the protruding part 41 without applying too much force. Thus, the opening protruding part 41 will not hinder the assembly worker in placing the lens 90, and the assembly worker can easily insert the lens 90 into the groove 50. Then the assembly worker can stop applying force to the protruding part 41. Via the elasticity of the flexible fastener 40, the protruding part 41 will be restored to its original position, and the protruding part 41 restored to its original position and the lens fastener 20 will fix the lens 90 in the groove 50. In addition, because of the flexibility of the flexible fastener 40, the flexible fastener 40 will not excessively compress the lens 90, and the lens 90 will not be deformed permanently by excessive pressure.

Therefore, by the design of the eyeglasses 100 of this invention, the assembly worker can easily assemble the frame 1 and the lens 90; further, during the assembly process, the force applied to the eyeglasses 100 by the assembly worker will not cause the frame 1 and the lens 90 to be permanently deformed, so the optical characteristics of the lens 90 will not be affected.

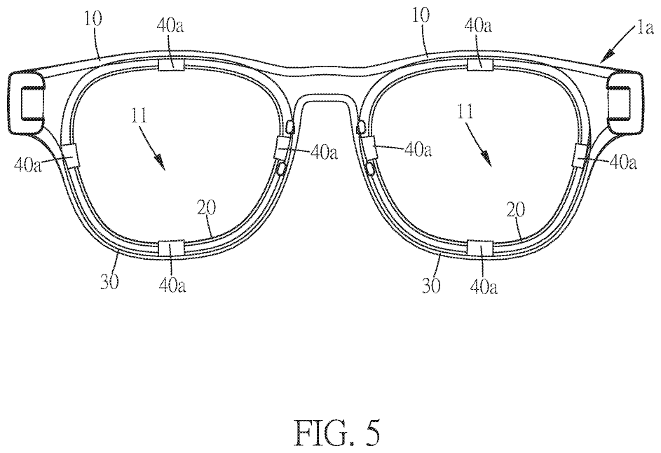

Please refer to FIG. 5, which illustrates the frame in a second embodiment of the present invention.

As shown in FIG. 5, the difference between the second embodiment and the first embodiment is that, in the second embodiment, the frame 1a includes eight flexible fasteners 40a, and the flexible fasteners 40a are block-shaped structures made of rubber or silicone. The rubber or silicone blocks of the eight flexible fasteners 40a are located around the hollow areas 11 of the two ring bodies 10. When the assembly worker needs to assemble the lens into the frame 1a, the assembly worker can push and open each of the flexible fasteners 40a sequentially such that the lens can be fastened between the lens fastener 20 and the flexible fastener 40a.

However, the amount of the flexible fasteners 40a is not limited to eight and can be changed according to the design requirement.

Please refer to FIG. 6, which illustrates the frame in a third embodiment of the present invention. FIG. 6 illustrates the schematic drawing of the ring body, the supporting unit and the flexible fastener combined with each other in the third embodiment of the present invention.

As shown in FIG. 6, the difference between the third embodiment and the first embodiment is that, in the frame 1b of the third embodiment, the combining part 12a of the ring body 10a is a C-shaped structure, the corresponding combining part 42a of the flexible fastener 40b is a protruding block, and the C-shaped structure of the combining part 12a and the protruding block of the corresponding combining part 42a are combined with each other stably. The supporting unit 30a further includes a blocking wall 31. Each of the blocking walls 31 and each of the ring bodies 10a which is corresponded to the blocking wall 31 hold each of the flexible fasteners 40b correspondingly from the opposite two sides. Via the combination of the combining part 12a and the corresponding combining part 42a, and the holding of the blocking wall 31 and the ring body 10a, the position of the flexible fastener 40b can be stable, and the flexible fastener 40b will not fall off from the supporting unit 30a.

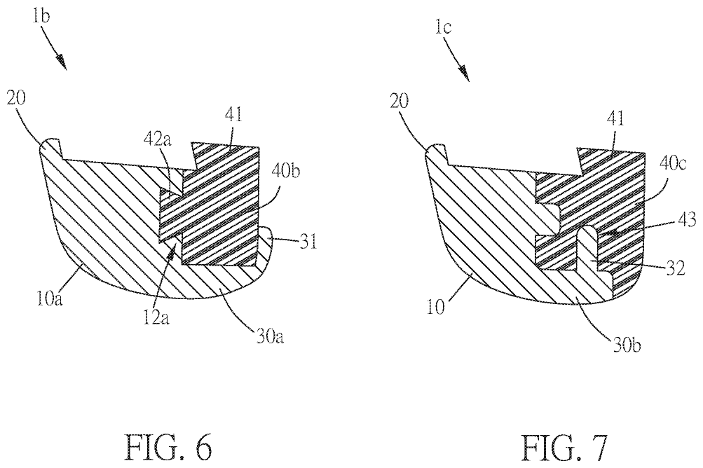

Please refer to FIG. 7, which illustrates the frame in the fourth embodiment of the present invention. FIG. 7 presents a schematic drawing of the ring body, the supporting unit and the flexible fastener combined with each other in the fourth embodiment of the present invention.

As shown in FIG. 7, the difference between the fourth embodiment and the first embodiment is that, in the frame 1c of the fourth embodiment, each of the supporting units 30b further includes a positioning part 32, and each of the flexible fasteners 40c includes a positioning groove 43. Each of the positioning parts 32 is fastened to the positioning groove 43 of the flexible fastener 40c which is corresponded to the positioning part 32; thus, the flexible fastener 40c can be stably located on the supporting unit 30a without falling off.

By the structural design of the eyeglasses and the frame of this invention, the assembly worker can assemble the frame and the lens easily; during the assembly process, the force applied by the assembly worker to the eyeglasses will not cause the frame and the lens to be permanently deformed, so the optical characteristics of the lens will not be affected.

What is claimed is:

1. A pair of eyeglasses, comprising:
two lenses; and
a frame, comprising:
two ring bodies, wherein the two ring bodies are connected to each other, and the two ring bodies each respectively comprises a hollow area;
two lens fasteners, respectively connected to the two ring bodies and respectively surrounding the hollow areas;
two supporting units, respectively connected to the two ring bodies; and
at least two flexible fasteners, respectively supported by the two supporting units, respectively located next to the two lens fasteners, and respectively combined with the two ring bodies; wherein two grooves are respectively formed between each of the two lens fasteners and the flexible fastener which is adjacent to the lens fastener, and each of the two grooves is respectively used for fixing each of the two lenses.

2. The pair of eyeglasses as claimed in claim 1, wherein the flexible fastener comprises a protruding part, wherein each of the two grooves is formed between the lens fastener and the protruding part which is adjacent to the lens fastener.

3. The air of eyeglasses as claimed in claim 2, wherein the ring body comprises a combining part, the flexible fastener comprises a corresponding combining part, and the combining part and the corresponding combining part are fastened to each other.

4. The pair of eyeglasses as claimed in claim 3, wherein the supporting unit comprises a blocking wall; the blocking wall and the ring body which is corresponded to the blocking wall hold the flexible fastener correspondingly.

5. The pair of eyeglasses as claimed in claim 3, wherein the supporting unit comprises a positioning part, the flexible fastener comprises a positioning groove, and the positioning part is fastened to the positioning groove of the flexible fastener which is corresponded to the positioning part.

6. The pair of eyeglasses as claimed in claim 1, wherein the at least two flexible fasteners are made of rubber or silicone.

7. The pair of eyeglasses as claimed in claim 1, wherein the two lenses respectively comprise a first sub-lens and a second sub-lens, and the first sub-lens is connected to the second su b-lens.

8. The pair of eyeglasses as claimed in claim 3, wherein the combining part is a protruding block, and the corresponding combining part is a C-shaped structure.

9. A frame, applied to an eyeglass, wherein the eyeglass comprises a lens, the frame comprising:
a ring body, comprising a hollow area;
a lens fastener, connected to the ring body and surrounding the hollow area;
a supporting unit, connected to the ring body; and
a flexible fastener, supported by the supporting unit, located next to the lens fastener, and combined with the ring body, wherein a groove is formed between the lens fastener and the flexible fastener which is adjacent to the lens fastener, and the groove is used for fixing the lens.

10. The frame as claimed in claim 9, wherein the flexible fastener comprises a protruding part, wherein the groove is formed between the lens fastener and the protruding part which is adjacent to the lens fastener.

11. The frame as claimed in claim 10, wherein the ring body comprises a combining part, the flexible fastener comprises a corresponding combining part, and the combining part and the corresponding combining part are fastened to each other.

12. The frame as claimed in claim 11, wherein the supporting unit comprises a blocking wall, and the blocking wall and the ring body hold the flexible fastener.

13. The frame as claimed in claim 11, wherein the supporting unit comprises a positioning part, the flexible fastener comprises a positioning groove, and the positioning part is fastened to the positioning groove of the flexible fastener.

14. The frame as claimed in claim 1, wherein the flexible fastener is made of rubber or silicone.

15. The frame as claimed in claim 11, wherein the combining part is a protruding block, and the corresponding combining part is a C-shaped structure; or wherein the combining part is a C-shaped structure, and the corresponding combining part is a protruding block.
